(19) United States
(12) Patent Application Publication
(10) Pub. No.: US 2020/0348817 A1
(43) Pub. Date: Nov. 5, 2020

(54) PEN TOUCH MATCHING

(71) Applicant: FlatFrog Laboratories AB, Lund (SE)

(72) Inventors: Nicklas OHLSSON, Bunkeflostrand (SE); Kristofer JAKOBSON, Malmo (SE)

(21) Appl. No.: 16/638,616

(22) PCT Filed: Aug. 10, 2018
(86) PCT No.: PCT/SE2018/050817

§ 371 Date: Feb. 12, 2020

(30) Foreign Application Priority Data
Aug. 23, 2017 (SE) 1730224-1

(51) Int. Cl. G06F 3/041; G06F 3/0354; G06F 3/038

(52) U.S. Cl. CPC G06F 3/04162; G06F 3/03545; G06F 2203/0384; G06F 2203/04106; G06F 3/038

(57) ABSTRACT

The present application describes a touch sensitive device comprising a touch sensor and a wireless receiver. The touch sensitive device is configured to: identify a new touch interaction at a position on the touch surface, receive a signal from a pen comprising a unique identifier, and match the new touch interaction to the one or more unique identifiers. The new touch interaction is matched to one of the unique identifiers in dependence on a confidence value of each of the unique identifiers and wherein the confidence value of each unique identifier is determined in dependence on characteristics of a previous touch interaction matched to the respective unique identifier.

### TECHNICAL FIELD

The present invention relates to techniques for detecting and identifying objects on a touch surface.

### BACKGROUND ART

To an increasing extent, touch-sensitive panels are being used for providing input data to computers, electronic measurement and test equipment, gaming devices, etc. The panel may be provided with a graphical user interface (GUI) for a user to interact with using e.g. a pointer, a pen (otherwise known as a stylus) or one or more fingers. The GUI may be fixed or dynamic. A fixed GUI may e.g. be in the form of printed matter placed over, under or inside the panel. A dynamic GUI can be provided by a display screen integrated with, or placed underneath, the panel or by an image being projected onto the panel by a projector.

There are numerous known techniques for providing touch sensitivity to the panel, e.g. by using cameras to capture light scattered off the point(s) of touch on the panel, by using cameras to directly observe the objects interacting with the panel, by incorporating resistive wire grids, capacitive sensors, strain gauges, etc. into the panel.

In one category of touch-sensitive panels known as ‘above surface optical touch systems’ and known from e.g. U.S. Pat. No. 4,459,476, a plurality of optical emitters and optical receivers are arranged around the periphery of a touch surface to create a grid of intersecting light paths (otherwise known as detection lines) above the touch surface. Each light path extends between a respective emitter/receiver pair. An object that touches the touch surface will block or attenuate some of the light paths. Based on the identity of the receivers detecting a blocked light path, a processor can determine the location of the intercept between the blocked light paths.

For many touch systems, a user may place a finger onto the surface of a touch panel to register a touch. Alternatively, a pen may be used. A pen is typically a pen shaped object with at least one end configured to be pressed against the surface of the touch panel. Use of a pen may provide improved selection accuracy and pointer precision over a simple finger touch. This can be due to the engineered pen tip providing a smaller and/or more regular contact surface with the touch panel than is possible with a human finger. Also, muscular control of an entire hand in a pen holding position can be more precise than a single finger for the purposes of pointer control due to lifelong training in the use of pens and pencils.

Known prior art describes systems for using radio and touch timing to differentiate between pens to allow touches detected on a touch surface to be matched to an ID of a respective pen. Force data corresponding to a force applied to a force sensor at the tip of the pen is sent via radio to the host system. Simultaneously, touch position data is transmitted from the touch sensor to the host system. In this system, data streams for the position data and the force data are separate. The data streams are then matched to identify touch events with corresponding events. For example, where a user presses a pen to the touch surface and the touch system recognises the contact on the touch surface (otherwise known as a ‘touch down event’ or ‘touch interaction’), the force data indicates a new force applied to the pen tip at the same time that the touch sensor indicates a new touch on the touch surface. As long as these two events occur within a time window of each other, they can be matched and the correct pen ID can be matched to the touch location.

However, combining the two data streams from the pen and the touch sensor for matching the pen data to the position data in systems where multiple pens and multiple other objects (e.g. finger touch and large objects) can be used becomes a non-trivial problem. In particular, when several events arrive within a time period comparable to the delay that can be expected from either of the data streams, matching touch position to pen ID can be difficult. Typically, this delay is also not fixed, but is dependent on the speed by which the object is brought into contact with the screen, the quality of the force sensor in the pen, the signal quality of the radio link etc.

Where two new pens are simultaneously applied to a touch screen and two simultaneous pen packets indicating touch down events are received by the host system, there is no way to know which pen ID to match to which touch position. This will either lead to pen mix-up if the wrong pen ID is assigned to a touch position or lost pen strokes if a pen is not assigned to the touch position at all. Furthermore, where variable delays are expected in the data streams, delays may be needed before matching can be performed with confidence, which provides a poor user experience with unacceptable touch latency.

Hence, an improved method of identifying unique pens and users would be advantageous and in particular allowing for avoiding more of the above-mentioned problems and compromises.

### SUMMARY

It is an objective of the invention to at least partly overcome one or more of the above-identified limitations of the prior art.

One or more of these objectives, as well as further objectives that may appear from the description below, are at least partly achieved by means of a method for data processing, a computer readable medium, devices for data processing, and a touch-sensing apparatus according to the independent claims, embodiments thereof being defined by the dependent claims.

In a first aspect of the invention, a touch sensitive device is provided comprising: a touch sensor configured to output a touch signal indicative of one or more touch interactions on a touch surface, and a wireless receiver for wirelessly receiving, from one or more pens, a pen event signal comprising a unique identifier of the pen, a processing unit configured to store previous touch interactions, unique identifiers, and matchings between touch interactions and corresponding unique identifiers, the touch sensitive device being configured to: identify, from the touch signal, a new touch interaction at a position on the touch surface, wirelessly receive a pen event signal comprising a unique identifier from one or more pens, and match the new touch interaction to the one or more unique identifiers, wherein matching the new touch interaction with one of the unique identifiers is performed in dependence on a confidence value of each of the unique identifiers and wherein the confidence value of each unique identifier is determined in dependence on characteristics of a previous touch interaction matched to the respective unique identifier.

In a second aspect of the invention, a method is provided of identifying a touch interacting between a pen and a touch sensitive device, the touch sensitive device comprising: a touch sensor configured to output a touch signal indicative of one or more touch interactions on a touch surface, and a wireless receiver for wirelessly receiving, from one or more pens, a unique identifier of each pen, a processing unit configured to store previous touch interactions, unique identifiers, and matchings between touch interactions and corresponding unique identifiers, the method comprising the steps of: identifying, from the touch signal, a new touch interaction at a position on the touch surface, wirelessly receiving a unique identifier from each of one or more pens, and matching the new touch interaction to the one or more unique identifiers, wherein matching the new touch interaction with one of the unique identifiers is performed in dependence on a confidence value of each of the unique identifiers and wherein the confidence value of each unique identifier is determined in dependence on characteristics of a previous touch interaction matched to the respective unique identifier.

### BRIEF DESCRIPTION OF DRAWINGS

These and other aspects, features and advantages of which embodiments of the invention are capable of will be apparent and elucidated from the following description of embodiments of the present invention, reference being made to the accompanying drawings:

FIG. 1 is a schematic illustration of a touch interaction system comprising a touch device and pens according to one example.

FIG. 2 is a schematic illustration of a touch interaction system according to one example.

### DETAILED DESCRIPTION OF EMBODIMENTS

Specific examples of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

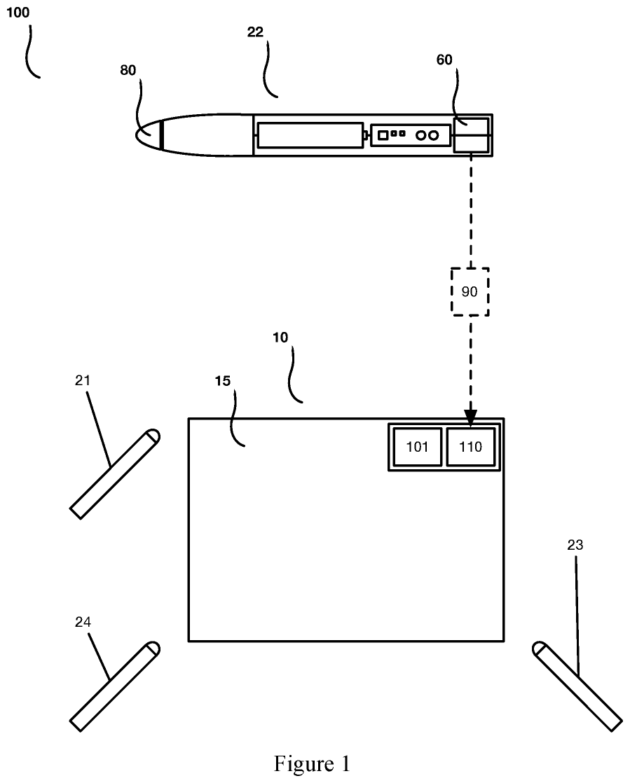

FIG. 1 shows a touch interaction system 100 comprising a first pen 22 and a touch sensitive device 10. The pen 22 comprises a wireless transmitter 60 adapted to transmit a unique identifier 90, and the touch sensitive device 10 comprises a receiver 110 adapted to receive the unique identifier 90 from the first pen 22. The pen 22 may be a first pen among a plurality of pens 21, 22, 23, 24, in the touch interaction system 100. The receiver 110 may be adapted to receive a unique identifier 90 from each of the plurality of pens 21, 22, 23, 24. The communication between the wireless transmitter 60 and the mentioned components in the touch interaction system 100 may be wireless communication.

In one embodiment, regular communication is maintained between pen 22 and receiver 110 as part of a continuous communication between the pen and the host device. Where a contact between the first pen 22 and a surface occurs (otherwise known as a ‘pen event’), a pen event signal, comprising the unique identifier 90 from the pen 22, may be sent to the receiver 110. Alternatively, pen event signal may be only transmitted when the pen event signal occurs, i.e. once a user engages a first pen 22 in contact with a touch surface of the touch sensor 15 or any other surface.

In one embodiment, the pen event signal comprises a time stamp to indicate the time of the pen event. The time of the pen event may correspond to a registered contact at contact detection unit 80 of the pen 22. Contact detection unit 80 may comprise a mechanical, electrical or optical sensor. The contact detection unit 80 may for example comprise a pressure sensor or any electro-mechanical actuator being adapted to register a pushing action of the pen against the touch sensor 15.

In a first embodiment, when an object is applied to the touch surface of touch sensor 15 of touch sensitive device 10, a touch signal indicative of one or more touch interactions on a touch surface is output to processing unit 101. Processing unit 101 is configured to process the touch signal to identify at least one existing or new touch interaction at a position on the touch surface. This new touch interaction may be known as a ‘touch down event’. In parallel, wireless receiver 110 is configured to receive any pen event signals transmitted by pens 22. Any unique identifiers 90 received by wireless receiver 110 as part of a pen event signal, and any touch down events on a touch surface may then be processed and stored by processing unit 101. Any matchings by processing unit 101 described below between pen events and touch down events may also be stored by processing unit 101.

Processing unit 101 is configured to match new touch downs to the one or more of the pen events processed by processing unit 101. The following describes a number of heuristics based on empirical user behaviour data that improve the matching of pen and position data, making pen-id mix-up less likely. Some embodiments are especially applicable to systems with incomplete information (e.g. due to delayed or lost radio packets or spurious pen trig packets from pens not touching the screen).

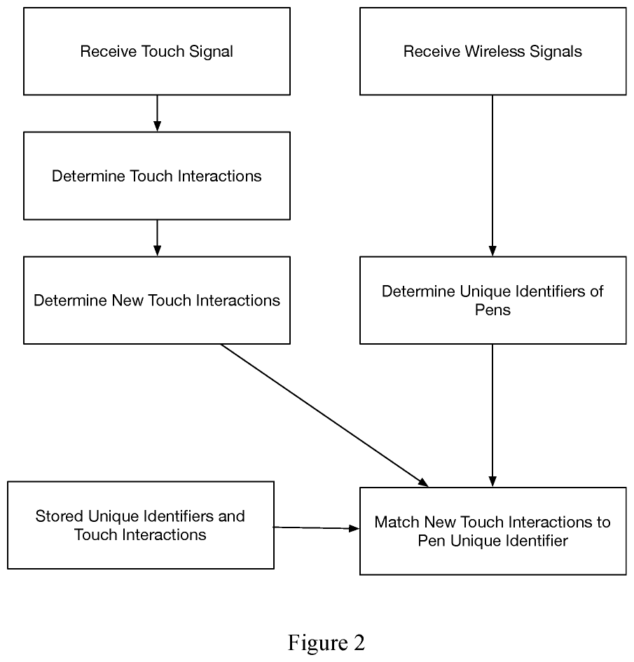

In one embodiment shown in FIG. 2, the processing unit 101 is configured to match the new touch down event with one of the received pen events in dependence on a confidence value of each of the one or more unique identifiers 90 of the pen events. The confidence value of each unique identifier may be determined in dependence on characteristics of previous touch down events (confidence characteristics) matched to the respective unique identifier. In an embodiment, a confidence value may be calculated by means of a number of iterative modifications made to an initial value, where each modification is calculated in dependence on one or more confidence characteristics. In another embodiment, the confidence value is calculated according to a single function using the confidence characteristics as variables in the function.

In one embodiment, the confidence value of each unique identifier is dependent on a distance between the position of the new touch down event and a position of one or more previous touch down events matched to the unique identifier. The confidence value of a unique identifier may be increased where the position of the new touch down event is close to a previous touch down event matched to the unique identifier. Similarly, the confidence value of a unique identifier may be decreased where the position of the new touch down event is far from a previous touch down event matched to the unique identifier. This advantageously allows processing unit 101 to match new touch down events with unique identifiers where the new touch down event is observed close to a position close to where the pen with the unique identifier was previously seen. In one example, where a user is writing text using a pen and is repeatedly lifting the pen off the touch surface before reapplying it close to the previous position, the processing unit 101 can determine that there is a high likelihood that the same pen is being used throughout the interaction. In one example, the confidence value of a unique identifier will be 1 for distances less than 20 cm and linearly decreasing until 0 for values larger than 40 cm.

In one embodiment, the confidence value of each unique identifier is dependent a period of time between the new touch down event and a previous touch down event matched to the unique identifier. In one embodiment, the confidence value of a unique identifier having a previous touch down event that occurred recently to the new touch down event is increased relative to the confidence value of a unique identifier having a previous touch down event that occurred less recently to the new touch down event. This advantageously allows processing unit 101 to match new touch down events with unique identifiers where the new touch down event is observed close in time to a previous pen. In one example, where a user is writing text using a pen and is repeatedly lifting the pen off the touch surface before reapplying rapidly, the processing unit 101 can determine that there is a high likelihood that the same pen is being used throughout the interaction. In one example, confidence value C(x)=−x/10+1, where C(x) is the confidence value and x is time in seconds.

In one embodiment, the processing unit is configured to store previously received pen events unmatched to a touch down event, including, optionally, the number of times a unique identifier 90 of the pen events have been unmatched to a touch down event. In this embodiment, the confidence value of a unique identifier is decreased where the unique identifier was previously unmatched to a touch down event a number of times. In one example, the confidence value is decreased in proportion to the number of times the unique identifier was previously unmatched to a touch down event. This advantageously allows processing unit 101 to identify pens that are being mishandled by a user and ignore pen signals received from these pens. E.g. Where a first user is holding a pen in their hand and nervously repeatedly activating the force sensor at the tip of the pen with their thumb. If a second user is using another pen with the touch system, the received pen signals of the mishandled pen should not be allowed to interfere with the matching of the second user's pen with the second user's touch down event. In one example, confidence value C(x)=1/(x+1), where C(x) is the confidence value and x is number of unmatched pen events within 60 seconds.

In one embodiment, matching between the new touch down event and a unique identifier of a pen event signal is delayed for a period of time when at least one condition is met that indicates that another pen event signal may be received with a unique identifier having a greater confidence value than any of the presently received unique identifier values. This advantageously allows processing unit 101 to wait for as-yet unreceived unique identifier values where it seems likely that an as-yet unreceived unique identifier value will be a better match than any of the present received unique identifier values. In this embodiment, for the period of time that the matching is delayed, the processing unit may continue to receive new pen event signals from receiving unit 110 and calculate confidence values for the newly received unique identifiers. Where a confidence value of a newly received unique identifier exceeds the confidence value of the confidence values of the existing unique identifier, the new touch down event may be matched to the newly received unique identifier.

In one example, matching between the new touch down event and a unique identifier is delayed for a period of time where a distance between the position of the new touch down event and a position of a previous touch down event matched to the unique identifier is above a threshold. This advantageously allows processing unit 101 to wait for further unique identifiers where the presently received unique identifiers are unlikely to be a correct matching for a new touch down event. In one embodiment, matching between the new touch down event and a unique identifier is delayed for 50 ms-100 ms or 7-15 frames where the distance between the position of the new touch down event and a position of a previous touch down event matched to the unique identifier is greater than 20 cm.

In one example, matching between the new touch down event and a unique identifier is delayed where a period of time between the new touch down event and a previous touch down event matched to the unique identifier is above a threshold. This advantageously allows processing unit 101 to wait for further unique identifiers where the presently received unique identifiers correspond to touch down events that were a long period of time in the past, whilst other unique identifiers previously matched to more recent touch down events are likely to be better candidates for the new touch down events. In one embodiment, matching between the new touch down event and a unique identifier is delayed for 50 ms-100 ms or 7-15 frames where the time between the new touch down event and the previous touch down event matched to the unique identifier is greater than 5 seconds.

In one example, matching between the new touch down event and a unique identifier is delayed for a period of time where the number of times the unique identifier has been previously unmatched to a touch down event is above a threshold. This advantageously allows processing unit 101 to wait for further unique identifiers where the presently received unique identifiers appear to correspond to a malfunctioning or mishandled pen. In one embodiment, matching between the new touch down event and a unique identifier is delayed for 50 ms-100 ms or 7-15 frames where the number of times the unique identifier has been previously unmatched to a touch down event is one or more times within the last 60 seconds.

In one example, matching between the new touch down event and a unique identifier is delayed for a period of time where the confidence value of the one or more unique identifier are below a threshold value. This advantageously allows processing unit 101 to wait for further pen event signals where the presently received unique identifiers appear to be a generally poor match for the new touch down event. In one example, matching between the new touch down event and a unique identifier is delayed for 50 ms-100 ms or 7-15 frames. The threshold value may be determined in dependence on a distance between the position of the new touch down event and a position of a previous touch down event matched to the unique identifier. The threshold value may alternatively, or in combination with the above, be determined in dependence on a distance between the position of the new touch down event and a position of a previous touch down event matched to the unique identifier. The threshold value may alternatively, or in combination with the above, be determined in dependence on a period of time between the new touch down event and a previous touch down event matched to the unique identifier, or a number of times the unique identifier has been previously unmatched to a touch down event.

In one example, matching between the new touch down event and a unique identifier is delayed for a period of time determined in dependence on a distance between the position of the new touch down event and a position of a previous touch down event matched to the unique identifier. In one example, matching between the new touch down event and a unique identifier is delayed for 50 ms delay if the distance is 20 cm or greater. Alternatively, or in combination with the above, the period of time may be determined in dependence on a period of time between the new touch down event and a previous touch down event matched to the unique identifier. In one example, matching between the new touch down event and a unique identifier is delayed for 50 ms if the previous touch down event was longer than 10 seconds ago. Alternatively, or in combination with the above, the period of time may be determined in dependence on a number of times the unique identifier has been previously unmatched to a touch down event. In one example, matching between the new touch down event and a unique identifier is delayed for 100 ms if any unique identifiers received in during last 60 seconds are unmatched to a touch down event. Alternatively, or in combination with the above, the period of time may be determined in dependence on the amount the confidence value of the unique identifier is below the threshold value. In one example, matching between the new touch down event and a unique identifier is delayed for 50 ms if the confidence value of the unique identifier is less than 0.5.

In one embodiment, matching between the new touch down event and a unique identifier may be delayed for a period of time where there exists an expected pen event signal with a unique identifier that has not yet been received. In such an embodiment, a confidence value is calculated for one or more unique identifiers that has not been presently received by the wireless unit. Where the confidence value of one or more unreceived unique identifiers has a higher confidence value than any of the one or more presently received unique identifiers, the processor unit is configured to delay the matching for a period of time. The unreceived unique identifiers having a high confidence value may indicate that the unreceived unique identifier has merely been delayed during transmission between the pen and the wireless receiver 110. The matching delay provides the unreceived unique identifier more time to be received. Once the time delay period has expired, the processor unit may be configured to match a received unique identifier to the new touch down event or provide no match for the new touch down event. In one embodiment, the confidence value of the unreceived unique identifier is determined as though the unreceived unique identifier has in fact been received. i.e. The confidence value of the unreceived unique identifier is determined as though it has a received time stamp equivalent to one of the presently received unique identifiers.

In one embodiment, matching between the new touch down event and a unique identifier is delayed for a period of time where a number of unmatched touch down events exceeds the number of received unique identifiers within a period of time (e.g. 20 seconds). Similarly, matching between the new touch down event and a unique identifier is delayed for a period of time where the number of received unique identifiers exceeds the number of touch down events.

In one embodiment, the period of time that the matching between the new touch down event and a unique identifier is delayed has a maximum length corresponding to a maximum wireless transmission time of a unique identifier from a pen to the touch sensitive device. E.g. 100 ms. In other embodiments, the period of time that the matching between the new touch down event and a unique identifier is delayed has a maximum length corresponding to a maximum delta between a new pen signal and a matching a unique identifier. E.g. 100 ms.

US patent publication US2010/0073318 discloses a technique for detecting and tracking multiple touch points on a touch surface using a Kalman tracker to match touch points determined in a current time frame with predicted locations of touch points determined in preceding time frames. For each predicted touch point, the nearest touch point in the current time frame is found in terms of Euclidian distance. In an embodiment of the present document, the confidence value of each unique identifier is dependent on a distance between the position of the new touch down event and a predicted position of a pen having the unique identifier, wherein the predicted position of the pen is determined on positions of a plurality of previous touch down events matched to the unique identifier of the pen.

The present invention has been described above with reference to specific embodiments. However, other embodiments than the above described are equally possible within the scope of the invention. The different features and steps of the invention may be combined in other combinations than those described. The scope of the invention is only limited by the appended patent claims.

More generally, those skilled in the art will readily appreciate that all parameters, dimensions, and configurations described herein are meant to be exemplary and that the actual parameters, dimensions, and/or configurations will depend upon the specific application or applications for which the teachings of the present invention is/are used.

1. A touch sensitive device comprising:
a touch sensor configured to output a touch signal indicative of one or more touch interactions on a touch surface, and
a wireless receiver for wirelessly receiving, from one or more pens, a pen event signal comprising a unique identifier of the pen,
a processing unit configured to store previous touch interactions, unique identifiers, and matchings between touch interactions and corresponding unique identifiers,
the touch sensitive device being configured to:
identify, from the touch signal, a new touch interaction at a position on the touch surface,
wirelessly receive a pen event signal comprising a unique identifier from one or more pens, and
match the new touch interaction to the one or more unique identifiers,
wherein matching the new touch interaction with one of the unique identifiers is performed in dependence on a confidence value of each of the unique identifiers and wherein the confidence value of each unique identifier is determined in dependence on characteristics of a previous touch interaction matched to the respective unique identifier.

2. The touch sensitive device of claim 1, wherein the confidence value of each unique identifier is dependent on one or more of:
a distance between the position of the new touch interaction and a position of a previous touch interaction matched to the unique identifier,
a period of time between the new touch interaction and a previous touch interaction matched to the unique identifier.

3. The touch sensitive device of claim 2, wherein the confidence value of a unique identifier having a previous touch interaction close to the position of the new touch interaction is increased relative to the confidence value of a unique identifier having a previous touch interaction further away from the position of the new touch interaction.

4. The touch sensitive device of claim 2, wherein the confidence value of a unique identifier having a previous touch interaction that occurred recently to the new touch interaction is increased relative to the confidence value of a unique identifier having a previous touch interaction that occurred less recently to the new touch interaction.

5. The touch sensitive device of claim 1, wherein the processing unit is configured to store previously received unique identifiers unmatched to a touch interaction, and wherein the confidence value of a unique identifier having been previously unmatched a fewer number of times is increased relative to the confidence value of a unique identifier having been previously unmatched a larger number of times.

6. The touch sensitive device of claim 1, wherein matching between the new touch interaction and a unique identifier is delayed for a period of time where at least one of the following conditions are met:
a distance between the position of the new touch interaction and a position of a previous touch interaction matched to the unique identifier is above a threshold,
a period of time between the new touch interaction and a previous touch interaction matched to the unique identifier is above a threshold,
a number of times the unique identifier has been previously unmatched to a touch interaction is above a threshold, or
the confidence value of the unique identifier is below a threshold value.

7. The touch sensitive device of claim 6, wherein, for the period of time, determining confidence values for newly received unique identifiers, and matching a newly received unique identifier to the touch interaction where the confidence value of the newly received unique identifier exceeds the confidence value of the unique identifier.

8. The touch sensitive device of claim 6, wherein distance between the position of the new touch interaction and a position of a previous touch interaction matched to the unique identifier is greater than 20 cm.

9. The touch sensitive device of claim 6, wherein the period of time between the new touch interaction and a previous touch interaction matched to the unique identifier is greater than 5 seconds.

10. The touch sensitive device of claim 6, wherein the number of times the unique identifier has been previously unmatched to a touch interaction is at least once within the last 60 seconds.

11. The touch sensitive device of claim 6, wherein the threshold value is determined in dependent on one or more of:
a distance between the position of the new touch interaction and a position of a previous touch interaction matched to the unique identifier,
a period of time between the new touch interaction and a previous touch interaction matched to the unique identifier, or
a number of times the unique identifier has been previously unmatched to a touch interaction.

12. The touch sensitive device of claim 6, wherein the period of time is determined in dependence on one or more of:
a distance between the position of the new touch interaction and a position of a previous touch interaction matched to the unique identifier,
a period of time between the new touch interaction and a previous touch interaction matched to the unique identifier,
a number of times the unique identifier has been previously unmatched to a touch interaction, or
the amount the confidence value of the unique identifier is below the threshold value.

13. The touch sensitive device of claim 1, wherein matching between the new touch interaction and a unique identifier is delayed for a period of time where an unreceived unique identifier is determined to have a higher confidence value than any of the one or more unique identifiers,
wherein an unreceived unique identifier is a unique identifier that was previously received but is not currently received, and
wherein a confidence value of the unreceived unique identifier is determined as though the unreceived unique identifier is currently received.

14. The touch sensitive device of claim 1, wherein matching between the new touch interaction and a unique identifier is delayed for a period of time where a number of touch interactions exceeds the number of received unique identifiers or where the number of received unique identifiers exceeds the number of touch interactions.

15. The touch sensitive device of claim 6 to 1, wherein the period of time has a maximum period corresponding to a maximum wireless transmission time of a unique identifier from a pen to the touch sensitive device.

16. The touch sensitive device of claim 1, wherein the confidence value of each unique identifier is dependent on a distance between the position of the new touch interaction and a predicted position of a pen having the unique identifier, wherein the predicted position of the pen is determined on positions of a plurality of previous touch interactions matched to the unique identifier of the pen.

17. A method of identifying a touch interacting between a pen and a touch sensitive device, the touch sensitive device comprising:
a touch sensor configured to output a touch signal indicative of one or more touch interactions on a touch surface, and
a wireless receiver for wirelessly receiving, from one or more pens, a unique identifier of each pen,
a processing unit configured to store previous touch interactions, unique identifiers, and matchings between touch interactions and corresponding unique identifiers,
the method comprising the steps of:
identifying, from the touch signal, a new touch interaction at a position on the touch surface,
wirelessly receiving a unique identifier from each of one or more pens, and
matching the new touch interaction to the one or more unique identifiers,
wherein matching the new touch interaction with one of the unique identifiers is performed in dependence on a confidence value of each of the unique identifiers and wherein the confidence value of each unique identifier is determined in dependence on characteristics of a previous touch interaction matched to the respective unique identifier.
